(19) United States
(12) Patent Application Publication
(10) Pub. No.: US 2013/0234591 A1
(43) Pub. Date: Sep. 12, 2013

(54) WHITE LIGHT EMITTING DEVICE

(71) Applicants: Yasushi Hattori, Kanagawa (JP); Naotoshi Matsuda, Kanagawa (JP); Kunio Ishida, Tokyo (JP); Aoi Okada, Kanagawa (JP); Ryosuke Hiramatsu, Kanagawa (JP); Masahiro Kato, Kanagawa (JP); Iwao Mitsuishi, Tokyo (JP)

(72) Inventors: Yasushi Hattori, Kanagawa (JP); Naotoshi Matsuda, Kanagawa (JP); Kunio Ishida, Tokyo (JP); Aoi Okada, Kanagawa (JP); Ryosuke Hiramatsu, Kanagawa (JP); Masahiro Kato, Kanagawa (JP); Iwao Mitsuishi, Tokyo (JP)

(21) Appl. No.: 13/677,675

(22) Filed: Nov. 15, 2012

(30) Foreign Application Priority Data
Mar. 8, 2012 (JP) 2012-051406

(51) Int. Cl. H05B 33/12; H05B 33/04

(52) U.S. Cl. CPC H05B 33/12; H05B 33/04
USPC 313/512; 313/498

(57) ABSTRACT

A white light emitting device of an embodiment includes: a light emitting element having a peak wavelength in a wavelength range from 430 to 470 nm both inclusive, a first fluorescent material formed over the light emitting element, and emitting light having a first peak wavelength of 530 to 580 nm both inclusive and having a first half width, and a second fluorescent material formed over the light emitting element, and emitting light having a second peak wavelength that is longer than the first peak wavelength and ranges from 570 to 620 nm both inclusive, and having a second half width that is 100 nm or less and is equal to or narrower than the first half width.

### CROSS-REFERENCE TO RELATED APPLICATION

This application is based upon and claims the benefit of priority from Japanese Patent Application No. 2012-051406, filed on Mar. 8, 2012, the entire contents of which are incorporated herein by reference.

### FIELD

Embodiments described herein relate generally to a white light emitting device.

### BACKGROUND

A light emitting device using a light emitting diode (LED) is made mainly of a combination of an LED chip as an exciting light source with a fluorescent material (or phosphor). In accordance with the kinds of the combination, various luminous colors can be realized.

For a white LED light emitting device which emits white light, a combination of an LED chip which emits light having a wavelength in the range of blue wavelengths with a fluorescent material has been used. Examples thereof include a combination of an LED chip which emits blue light with a fluorescent material. As the fluorescent material, a fluorescent material that emits yellow color is mainly used, the color being a color complementary to blue. This combination is used as a pseudo-white light LED. As another example of the white LED, a three-wavelength type white LED has been developed, which makes use of an LED chip which emits blue light together with a green or yellow fluorescent material, and a red fluorescent material.

With respect to white light emitting devices, in order to reproduce a color close to that of natural light, it is desired to realize a high color rendering index (or color rendering property), in particular, a high average color rendering index (Ra). Furthermore, in order to make the power consumption thereof low, it is required to make the high index (Ra) compatible with a high luminous efficiency.

### BRIEF DESCRIPTION OF THE DRAWINGS

FIG. 1 is a schematic sectional view of alight emitting device of an embodiment;

FIGS. 2A and 2B are each a chart showing an example of emission spectra obtained by simulations;

FIG. 3 is a chart showing an example of results from the simulations according to the embodiment;

FIGS. 4A to 4D are each a chart showing the half width dependency of the color rendering index, and the luminous efficiency of a sample;

FIGS. 5A to 5D are each a chart showing the half width dependency of the color rendering index, and the luminous efficiency of a sample;

FIGS. 6A to 6D are each a chart showing the half width dependency of the color rendering index, and the luminous efficiency of a sample; and

FIGS. 7A to 7D are each a chart showing the half width dependency of the color rendering index, and the luminous efficiency of a sample.

### DETAILED DESCRIPTION

The white light emitting device of an aspect includes: a light emitting element having a peak wavelength in a wavelength range from 430 to 470 nm both inclusive, a first fluorescent material formed over the light emitting element, and emitting light having a first peak wavelength of 530 to 580 nm both inclusive and having a first half width, and a second fluorescent material formed over the light emitting element, and emitting light having a second peak wavelength that is longer than the first peak wavelength and ranges from 570 to 620 nm both inclusive, and having a second half width that is 100 nm or less and is equal to or narrower than the first half width.

Hereinafter, referring to the drawings, the aspect, and embodiments thereof will be described. In this specification, “half width” means full width at half maximum (FWHM).

The white light emitting device of the aspect includes: a light emitting element having a peak wavelength in a wavelength range from 430 to 470 nm both inclusive, a first fluorescent material formed over the light emitting element, and emitting light having a first peak wavelength of 530 to 580 nm both inclusive and having a first half width (a first FWHM), and a second fluorescent material formed over the light emitting element, and emitting light having a second peak wavelength that is longer than the first peak wavelength and ranges from 570 to 620 nm both inclusive, and having a second half width (a second FWHM) that is 100 nm or less and is equal to or narrower than the first half width.

The white light emitting device of the aspect has the above-mentioned structure. By this matter, the device can realize a high color rendering index, in particular, a high average color rendering index (or color rendering property) Ra and a high luminous efficiency. In other words, when a light emitting element which emits blue light is combined with two fluorescent materials that are different in peak wavelength from each other and belong to fluorescent materials ranging from yellowish green fluorescent materials to orange fluorescent materials, a high color rendering index and a high luminous efficiency can be made compatible with each other.

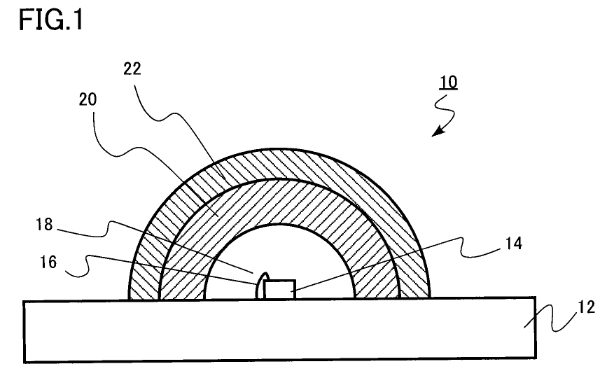

FIG. 1 is a schematic sectional view of a light emitting device of one of the embodiments. This light emitting device, which is a device 10, is a white light emitting device which emits white light. The device is, in particular, a white light emitting device giving a luminous color which is a neutral white (5000 K).

The white light emitting device 10 has a substrate 12 having a plane on which a light emitting element is to be mounted. For the substrate 12, for example, a highly reflective material is used.

The light emitting element may be a light emitting element 14 which emits light having a peak wavelength in a wavelength range from 430 to 470 nm both inclusive. As the light emitting element 14, for example, a blue LED is mounted on the plane of the substrate 12. The blue LED is connected to an interconnect not illustrated through, for example, a golden wire 16. When a driving current is supplied from the outside through the interconnect to the blue LED, the blue LED generates exciting blue light.

The blue LED is, for example, an AlGaInN based LED having a light emitting layer including GaInN.

An element sealing transparent layer 18 made of a transparent resin in a semispherical form is laid on the light emitting element 14. The transparent resin is, for example, a silicone resin.

Furthermore, a first fluorescent material layer 20 is formed to cover the element sealing transparent layer 18. With respect to the layer 20, a cross section thereof perpendicular to the plane has a semispherical outer circumferential shape.

The first fluorescent material layer 20 contains a first fluorescent material which makes use of light emitted from the light emitting element 14, as exciting light, to emit light having a first peak wavelength of 530 to 580 nm both inclusive and having a first half width.

The first fluorescent material, which may be referred to as the fluorescent material Y1 hereinafter, is one out of fluorescent materials ranging from yellowish green fluorescent materials to yellow fluorescent materials. The first fluorescent material layer 20 is formed by dispersing particles of the one fluorescent material, out of these fluorescent materials, into, for example, a transparent silicone resin. The first fluorescent material layer 20 absorbs blue light generated from the blue LED to convert the blue light to light in one out of colors ranging from yellowish green to yellow.

A second fluorescent material layer 22 is formed to cover the first fluorescent material layer 20. With respect to the layer 22, a cross section thereof perpendicular to the plane has a semispherical outer circumferential shape. The second fluorescent material layer 22 contains a second fluorescent material which makes use of light emitted from the light emitting element 14, as exciting light, to emit light having a second peak wavelength of 570 to 620 nm both inclusive and having a second half width that is 100 nm or less and is equal to or narrower than the first half width.

The second fluorescent material, which may be referred to as the fluorescent material Y2 hereinafter, is one out of fluorescent materials ranging from yellow fluorescent materials to orange fluorescent materials. The second fluorescent material layer 22 is formed by dispersing particles of the one fluorescent material, out of these fluorescent materials, into, for example, a transparent silicone resin. The second fluorescent material layer 22 absorbs blue light generated from the blue LED to convert the blue light to light in one out of colors ranging from yellow to orange.

The first fluorescent material Y1 may be, for example, a YAG:Ce based fluorescent material.

The second fluorescent material Y2 may be, for example, a silicate based fluorescent material. Silicate based fluorescent materials are small in a change in the specific gravity, particle shape and absorption spectrum thereof which follows a fluctuation in the emission wavelength thereof. Thus, it is easy to mix silicate based fluorescent materials different in emission wavelength with each other, and use the resultant as a single fluorescent material to produce a device. For this reason, the device production can be made easy and simple.

Specific examples of the silicate based fluorescent material include (Sr_{(1-x-y-z)}BaₓCa_{y}Eu_{z})₂Si₂O₄ wherein 0≦x<1, 0≦y≦1, 0.05≦z≦0.2, or (Sr_{(1-x-y-z)}BaₓCa_{y}Eu_{z})Si₂O₂N₂ wherein 0≦x<1, 0≦y≦1, and 0.01≦z≦0.2.

With respect to the silicate based fluorescent material represented by the above-mentioned formulas, the emission wavelength thereof can be adjusted by changing respective values of x and y, which are related to the composition of the fluorescent material. Thus, from the same base material of the fluorescent material, fluorescent material kinds giving a plurality of emission wavelengths, respectively, can be obtained. In order to stabilize the crystal structure thereof, or heighten the fluorescent material in emission intensity, strontium (Sr), barium (Ba), and calcium (Ca) may be partially substituted with at least one of Mg and Zn. Usable examples of the silicate based fluorescent material having a different composition include MSiO₃, MSiO₄, M₂SiO₃, M₂SiO₅, M₃SiO₅, and M₄Si₂O₈ wherein each M is at least one element selected from the groups including Sr, Ba, Ca, Mg, Be, Zn and Y. In order to control the luminous color, Si may be partially substituted with germanium (Ge) (for example, (Sr_{(1-x-y-z)}BaₓCa_{y}Eu_{z})₂(Si₂₍₁₋ᵤ₎)Geᵤ)O₄). The silicate based fluorescent material may contain, as a co-activating agent, at least one element selected from the group including Ti, Pb, Mn, As, Al, Pr, Tb, and Ce.

Specifically, by using, as a short-wavelength-fluorescent material, a fluorescent material wherein Ce is activated to give a wide half width and further using, as a long-wavelength-fluorescent material, a fluorescent material wherein Eu is activated to give a narrow half width, a white light emitting device can be obtained which is higher in luminous efficiency and color rendering index.

For example, the first fluorescent material (Y1) and the second fluorescent material (Y2) may be a YAG:Ce fluorescent material having a peak wavelength of 548 nm and a half width of about 110 nm, and a silicate based fluorescent material having a peak wavelength of 584 nm, and a half width of about 90 nm, respectively.

With respect to the fluorescent material obtained in this case, the lumen equivalent obtained from the spectrum thereof is 328 lm/W, and the index Ra is 74.

On the other hand, when a fluorescent material of only a single kinds, for example, a fluorescent material wherein only a single-kinds fluorescent material YAG:Ce is used, the lumen equivalent is 326 lm/W, and the index Ra is 72. Thus, in the embodiment, wherein two kinds are used out of fluorescent materials ranging from yellow to orange fluorescent materials, a high color rendering index and a high luminous efficiency are realized.

Hereinafter, a description will be made about results from simulations that show the effects and advantages of the embodiment. In the simulations, the respective color rendering index and luminous efficiency of white light emitting devices were obtained.

In each of the simulations, a calculation was made by adding an actually measured spectrum of a blue LED to one or two Gaussian-approximated spectra of one or two out of fluorescent materials ranging from yellowish green fluorescent materials to orange fluorescent materials. It was beforehand verified by use of each of typical examples of fluorescent materials ranging from yellowish green fluorescent materials to orange fluorescent materials that the difference in simulation result is small between an actually measured spectrum thereof and a Gaussian-approximated spectrum thereof, so that no practical problem is caused by the simulations about the calculation of the color rendering index and the luminous efficiency of such a fluorescent material.

With respect to the luminous efficiency of any sample to be simulated, a theoretical value of the luminous efficiency, that is, the lumen equivalent was used as an index in order to ignore the efficiency of its light emitting element and the efficiency of its fluorescent material(s).

For comparison, about a combination of the blue light emitting element with a single-kinds yellow fluorescent material, the color rendering index and the luminous efficiency were first simulated.

The half width of the yellow fluorescent material was used as a variation to adjust the ratio between the peak wavelength and the peak intensity of the yellow fluorescent material so as to make, into the chromaticity of a 5000 K neutral white (Cx=0.3452, and Cy=0.3517), the spectrum obtained by totalizing the spectrum of the blue LED (emission wavelength: 455 nm) and that of the yellow fluorescent material. The peak wavelength was near 570 nm.

Next, about each combination of the (same) blue light emitting element (as described above) with two that were selected from fluorescent materials ranging from yellowish green fluorescent materials to orange fluorescent materials and were different from each other in peak wavelength, the color rendering index and the luminous efficiency were simulated. Hereinafter, a fluorescent material having a short peak wavelength, out of the two fluorescent materials in the combination, will be hereinafter referred to as the fluorescent material Y1; and one having a peak wavelength longer than the short peak wavelength, as the fluorescent material Y2.

The half width and the emission wavelength of each of the fluorescent materials Y1 and Y2 were each used as a variation to adjust the ratio between their peak intensities so as to make, into the chromaticity of a 5000 K neutral white (Cx=0.3452, and Cy=0.3517), the spectrum obtained by totalizing the spectrum of the blue LED (emission wavelength: 455 nm), and the respective spectra of the two fluorescent materials.

In a specific process of the simulation, under a condition that the half width of each of the fluorescent materials Y1 and Y2 was made into a numeric constant, the peak wavelength of the fluorescent material Y1 was changed from 530 to 580 nm at intervals of 2 nm, and that of the fluorescent material Y2 was changed from 570 to 620 nm at intervals of 2 nm. In any combination of the respective peak wavelengths of the two fluorescent materials, the intensity ratio between the fluorescent materials Y1 and Y2 was adjusted to make the spectrum of the combination into the chromaticity of a 5000 K neutral white. From the resultant spectrum, the color rendering index and the luminous efficiency were gained.

Thereafter, substantially the same simulations were made while the combination of the respective half widths of the fluorescent materials Y1 and Y2 was varied.

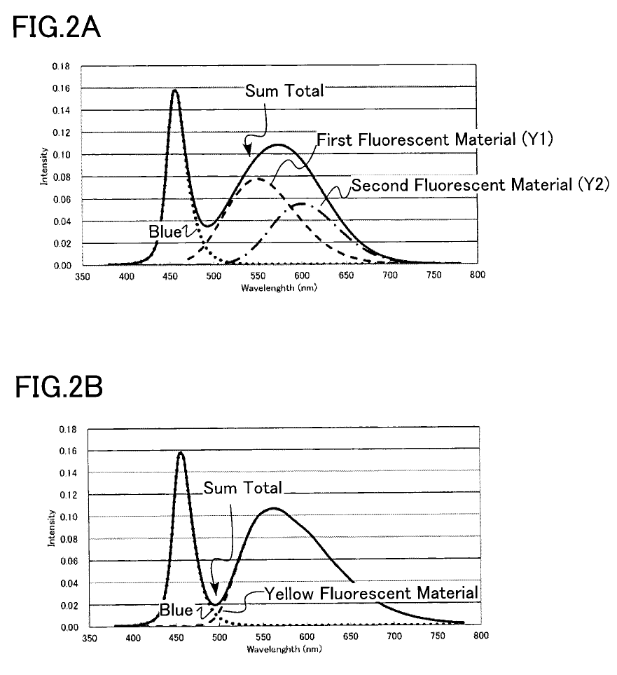

FIGS. 2A and 2B are each a chart showing an example of the emission spectra yielded in the simulations. FIG. 2A shows a spectrum according to the present embodiment; and FIG. 2B shows a spectrum according to a case where the single-kinds yellow fluorescent material was used.

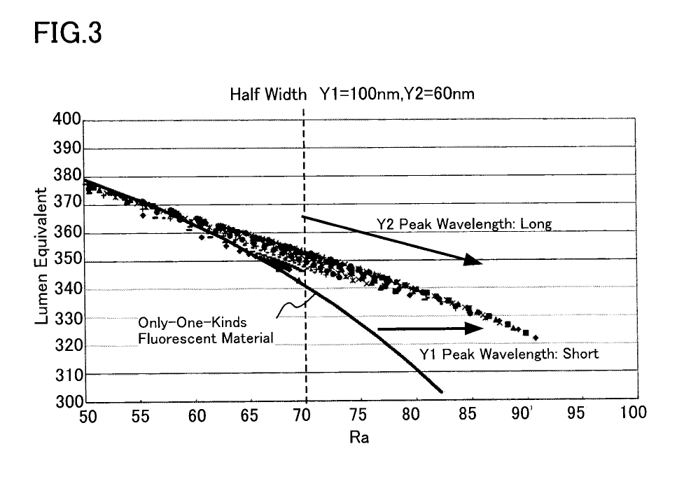

FIG. 3 is a chart showing an example of the results from the simulations according to the embodiment. This chart shows a simulation result of a case where the half width of the fluorescent material Y1 was 100 nm, and that of the fluorescent material Y2 was 60 nm.

The transverse axis and the vertical axis thereof represent the average color rendering index Ra and the lumen equivalent (lm/W), respectively. In the chart, a solid line shows a case (or sample) where the single-kinds yellow fluorescent material was used. Individual plotted marks show cases (or samples) where the two fluorescent materials Y1 and Y2 were used. Out of the marks, the same type marks show one out of cases where the peak wavelength of the fluorescent material Y1 was the same.

In FIG. 3, at the marks above the curve (solid line) of the case where the single-kinds yellow fluorescent material was used, the color rendering index and luminous efficiency were made better than those of the case where the single-kinds yellow fluorescent material was used.

Whether any one of all the samples was a case where the single fluorescent material was used, or a case where the two fluorescent materials were used, the color rendering index and the luminous efficiency thereof had a tradeoff relationship. This appears to be based on the following: when the emission spectrum of the sample is made board in order to heighten the color rendering index thereof, increased is the area of a portion obtained by excluding, from the emission spectrum, a wavelength range of about 555 nm, in which a maximum visibility is exhibited.

As shown in FIG. 3, however, the use of the two-kinds fluorescent materials Y1 and Y2 makes the sample (concerned) better in color rendering index and luminous efficiency than the use of the single-kinds yellow fluorescent material. More specifically, as the peak wavelength of the fluorescent material Y1 becomes shorter, the sample tends to be made betters in color rendering index and luminous efficiency. When the peak wavelength of the fluorescent material Y1 is not varied, the sample tends to be made better in color rendering index and luminous efficiency as the peak wavelength of the fluorescent material Y2 is longer, in other words, as the difference in peak wavelength between the fluorescent materials Y1 and Y2 is larger.

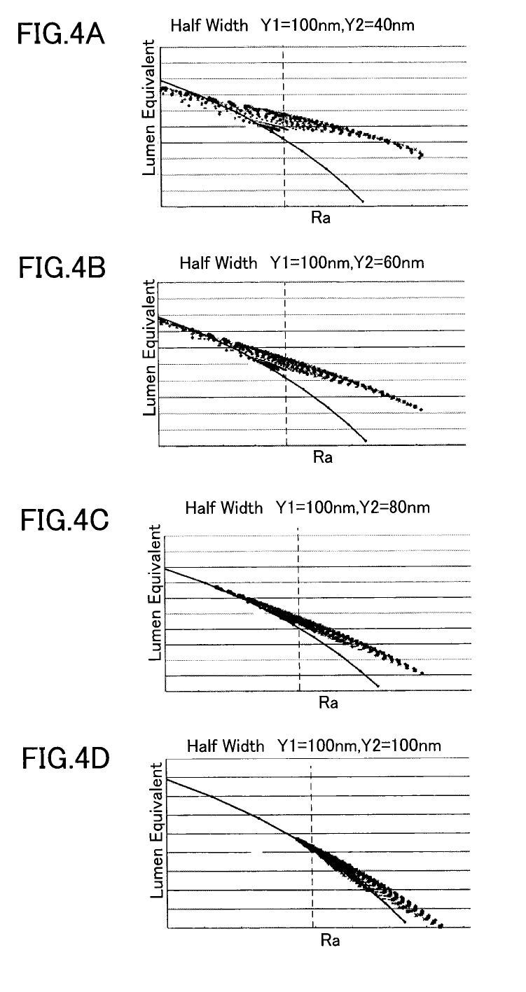

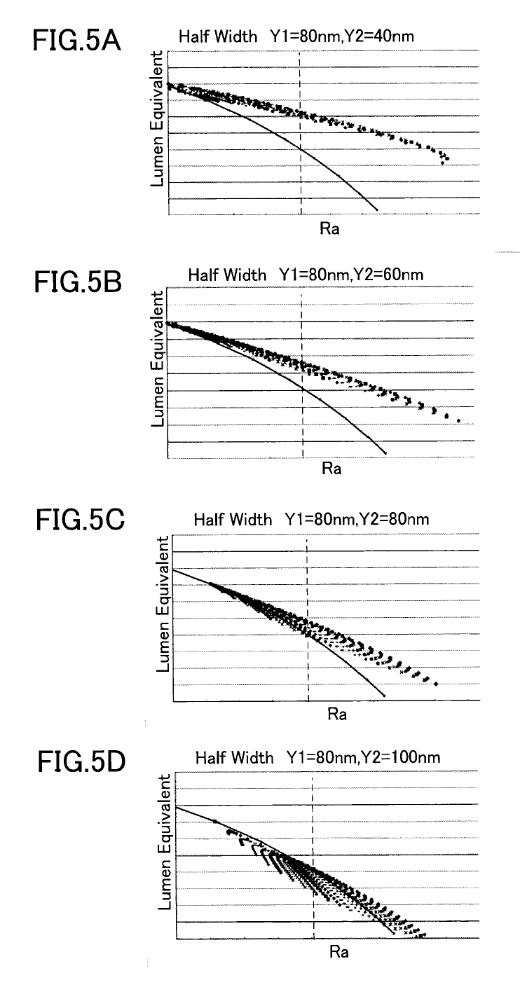

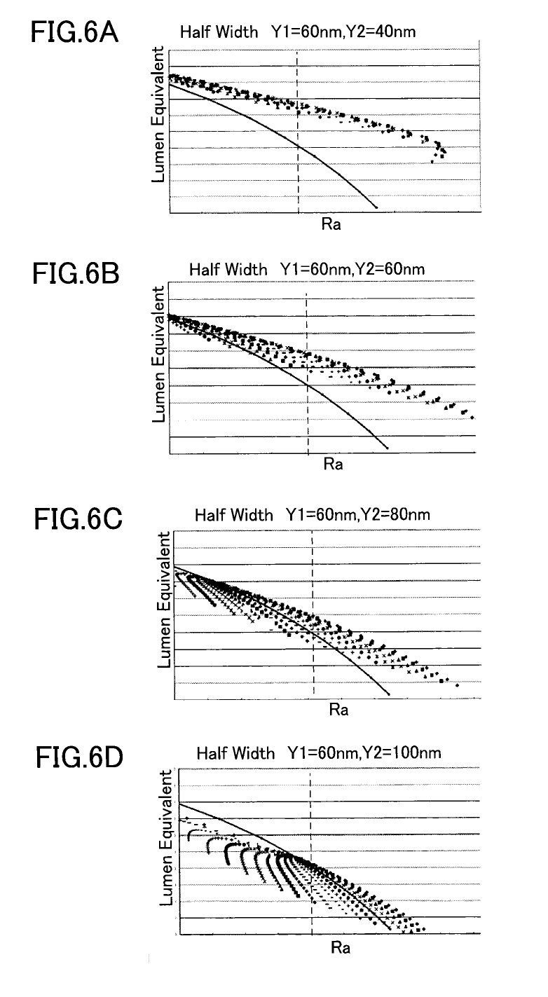

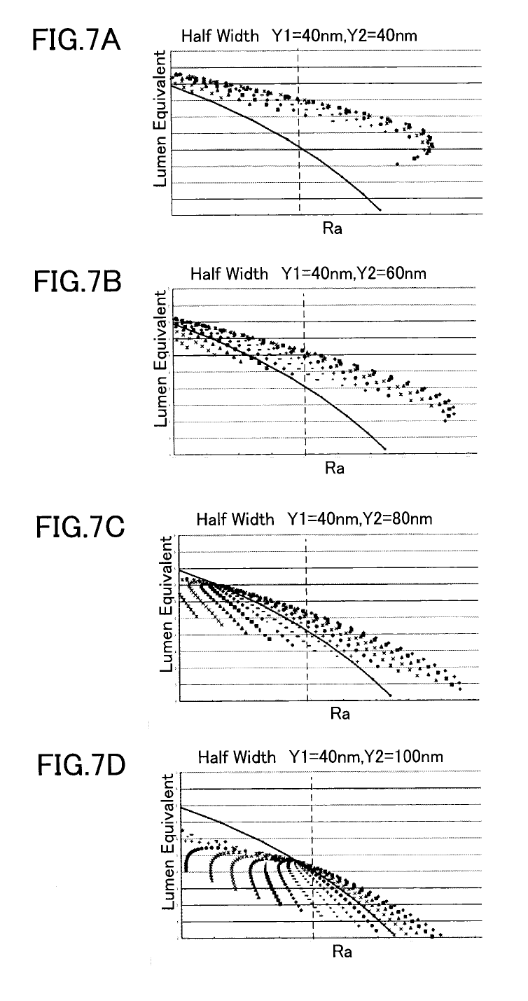

FIGS. 4A to 4D, as well as FIGS. 5A to 5D, FIGS. 6A to 6D and FIGS. 7A to 7D, are each a chart showing the half width dependency of the color rendering index and the luminous efficiency of a sample. FIGS. 4A to 4D each shows a case where the half width of the fluorescent material Y1 is 100 nm; FIGS. 5A to 5D, one where the width is 80 nm; FIGS. 6A to 6D, one where the width is 60 nm; and FIGS. 7A to 7D, one where the width is 40 nm. In each of the figures, shown are results where values of the half width of the fluorescent material Y2 are 40 nm, 60 nm, 80 nm and 100 nm, respectively.

In each of the figures, a vertical dot line is an axis at which the index Ra is 70.

As is evident from 4A to 4D, as well as FIGS. 5A to 5D, FIGS. 6A to 6D and FIGS. 7A to 7D, when the (second) half width of a fluorescent material Y2 (second fluorescent material) is equal to or narrower than the (first) half width of a fluorescent material Y1 (first fluorescent material), the color rendering index and the luminous efficiency are made better than when a single-kinds yellow fluorescent material is used.

Furthermore, when the (second) half width of the fluorescent material Y2 (second fluorescent material) is 60 nm or less, the advantageous effect becomes remarkable. It is therefore desired that the (second) half width of the fluorescent material Y2 (second fluorescent material) is 60 nm or less.

The index Ra is desirably 70 or more from the viewpoint of practical use. In a region where the index Ra is 70 or more (right side region of the dot line in each of the figures), the (first) peak wavelength of the fluorescent material Y1 (first fluorescent material) is desirably 550 nm or less in order to make the color rendering index and the luminous efficiency better than those in the case of the single-kinds yellow fluorescent material. It is also desirable to set, to 40 nm or more, the difference between the (second) peak wavelength of the fluorescent material Y2 (second fluorescent material) and the (first) peak wavelength of the fluorescent material Y1.

In order to realize an Ra of 80 or more, which is not easily realized by the single-kinds yellow fluorescent material since the luminous efficiency thereof is substantially declined, it is desirable to set, to 545 nm or less, the (first) peak wavelength of the fluorescent material Y1 (first fluorescent material). It is also desirable to set, to 60 nm or more, the difference between the (second) peak wavelength of the fluorescent material Y2 (second fluorescent material) and the (first) peak wavelength of the fluorescent material Y1.

The (first) half width of the fluorescent material Y1 is preferably 120 nm or less, considering a balance between the index Ra and the luminous efficiency.

It is allowable to incorporate, into two kinds out of fluorescent materials ranging from yellowish green fluorescent materials to orange fluorescent materials in the fluorescent material layer in the embodiment, a different-kinds fluorescent material. However, when the number of the kinds of the fluorescent materials is made into three or more, the luminous efficiency may be unfavorably declined by re-absorption or the like between the fluorescent materials. It is therefore desirable that the fluorescent materials contained in the fluorescent material layer are only two out of fluorescent materials ranging from yellowish green fluorescent materials to orange fluorescent materials.

According to the embodiment, a white light emitting device can be provided which can realize a high color rendering index and a high luminous efficiency.

In the embodiment, the description has been made, giving, for example, a case of using an AlGaInN based LED in which an emissive layer includes GaInN. In another embodiment, use may be made of an LED wherein an emissive layer (active layer) includes aluminum gallium indium nitride (AlGaInN), which is a Group III-V compound semiconductor, magnesium zinc oxide (MgZnO), which is a Group II-VI compound semiconductor, or some other compound. For example, the Group III-V compound semiconductor used for the emissive layer is a nitride semiconductor containing at least one selected from the group including Al, Ga and In. This nitride semiconductor is specifically represented by AlₓGa_{y}In_{(1-x-y)}N wherein 0≦x≦1, 0≦y≦1, and 0≦(x+y)≦1. Examples of such a nitride semiconductor include binary semiconductors such as AlN, GaN, and InN; ternary semiconductors such as AlₓGa₍₁₋ₓ₎N wherein 0<x<1, AlₓIn₍₁₋ₓ₎N wherein 0<x<1, and Ga_{y}In_{(1-y)}N wherein 0<y<1; and quaternary semiconductors each including all of Al, Ga and In. On the basis of the values of x, y and (1-x−y), which are each related to the proportion of Al, Ga or In, an emission peak wavelength is decided within the range of ultraviolet to blue wavelengths. Moreover, the Group III elements may be partially substituted with boron (B), thallium (Ta), or some other element. Furthermore, N, which is a Group V element, may be partially substituted with fluorescent materialous (P), arsenic (As), antimony (Sb), bismuth (Bi), or some other element.

Similarly, the Group II-VI compound semiconductor used for the emissive layer may be an oxide semiconductor containing at least one of Mg and Zn. Specifically, the semiconductor may be a semiconductor represented by Mg_{z}Zn_{(1-z)}O wherein 0≦z≦1. On the basis of the values of z and (1-z), which are each related to the proportion of Mg or Zn, an emission peak wavelength is decided within the range of ultraviolet wavelengths.

With respect to the material of the transparent substrate of the fluorescent material layer, the description has been made, giving silicone resin as an example. However, the material may be any material high in exciting-light transmissibility, and high in heat resistance. Examples of the material include, besides silicone resin, epoxy resin, urea resin, fluorine-contained resin, acrylic resin, and polyimide resin. Epoxy resin or silicone resin is in particular preferably used since the resin is easily available, is easily handleable and is inexpensive. The material may be, besides resin, for example, glass or a sintered body.

The fluorescent materials ranging from yellowish green fluorescent materials to orange fluorescent materials are each formed of a material which absorbs light in the range of blue wavelengths to emit a visible light ray. Examples thereof include, besides YAG:Ce fluorescent materials and silicate based fluorescent materials described in the above-mentioned embodiment, nitride and oxynitride based fluorescent materials, Si-containing oxynitride fluorescent materials (SION), and fluorescent materials each containing, as a mother material, an aluminate based, sulfide based, oxysulfide based, boride based, phosphate boride based, phosphate based, or halophosphate based compound. Respective compositions of some of these fluorescent materials are described below.

Aluminate based fluorescent materials: An examples thereof is M₂Al₁₀O₁₇ wherein M is at least one element selected from the group including Ba, Sr, Mg, Zn, and Ca:

The fluorescent materials each contain, as an activating agent, at least one of Eu and Mn. Examples of other compositions of the aluminate based fluorescent materials include MAl₂O₄, MAl₄O₁₇, MAl₈O₁₃, MAl₁₂O₁₉, M₂Al₁₉O₁₇, M₂Al₁₁O₁₉, M₃Al₅O₁₂, M₃Al₁₆O₂₇, and M₄Al₅O₁₂ wherein M is at least one element selected from the group including Ba, Sr, Ca, Mg, Be and Zn. The fluorescent materials each contain, as an activating agent, at least one element selected from the group including Mn, Dy, Tb, Nd and Ce.

Nitride based fluorescent materials (mainly, silicon nitride based fluorescent materials), and oxynitride based fluorescent materials: An example thereof is LₓSi_{y}N_{(2x/3+4y/3)}:Eu, or LₓSi_{y}O_{z}N_{(2x/3+4y/3-2z/3)}:Eu wherein L is at least one element selected from the group including Sr and Ca:

In this composition, it is desirable that x is 2 and y is 5, or x is 1 and y is 7 although x and y may each be made into any value. As the nitride based fluorescent materials represented by the formula, it is desirable to use the fluorescent materials including (SrₓCa₍₁₋ₓ₎)₂Si₅N₈:Eu, Sr₂Si₅N₈:Eu, Ca₂Si₅N₈:Eu, SrₓCa₍₁₋ₓ₎Si₇N₁₀:Eu, SrSi₇N₁₀:Eu, and CaSi₇N₁₀:Eu, to each of these compounds Mn being added as an activating agent. These fluorescent materials may each contain at least one element selected from the group including Mg, Sr, Ca, Ba, Zn, B, Al, Cu, Mn, Cr and Ni. The fluorescent materials may each contains, as an activating agent, at least one element selected from the group including Ce, Pr, Tb, Nd, and La. Other examples of the fluorescent materials include sialon based fluorescent materials, wherein Si is partially substituted with Al, i.e., LₓSi_{y}Al_{(12-y)}O_{z}N_{(16-z)}:Eu wherein L is at least one element selected from the group including Sr and Ca.

Sulfide based fluorescent materials: An example thereof is (Zn₍₁₋ₓ₎Cdₓ₎S:M wherein M is at least one element selected from the group including Cu, Cl, Ag, Al, Fe, Cu, Ni, and Zn, and x is a numerical value satisfying the expression of 0≦x≦1:

S may be substituted with at least one of Se and Te.

Boride based fluorescent materials: An example thereof is MBO₃:Eu wherein M is at least one element selected from the group including Y, La, Gd, Lu, and In:

The fluorescent materials may each contain, as an activating agent, Tb. Examples of boride based fluorescent materials having other compositions include Cd₂B₂O₅:Mn, (Ce, Gd, Tb)MgB₅O₁₀:Mn, and GdMgB₅O₁₀:Ce, Tb.

Phosphate boride based fluorescent materials: An example thereof is 2(M₍₁₋ₓ₎M′ₓ)O.aP₂O₅.bB₂O₃ wherein M is at least one element selected from the group including Mg, Ca, Sr, Ba, and Zn, M′ is at least one element selected from the group including Eu, Mn, Sn, Fe and Cr, and x, a and b are each a numerical value satisfying the expressions of 0.001≦x≦0.5, 0≦a≦2, 0≦b≦3, and 0.3<(a+b):

Phosphate based fluorescent materials: An example thereof is (Sr₍₁₋ₓ₎Baₓ)₃(PO₄)₂:Eu, or (Sr₍₁₋ₓ₎Baₓ)₂P₂O₇:Eu, Sn:

The fluorescent materials may each contain, as an activating agent, at least one of Ti and Cu.

Halophosphate based fluorescent materials: An example thereof is (M₍₁₋ₓ₎Euₓ)₁₀(PO₄)₅Cl₂, or (M₍₁₋ₓ₎Euₓ)₅(PO₄)₃Cl wherein M is at least one element selected from the group including Ba, Sr, Ca, Mg, and Cd, and x is a numerical value satisfying the expression of 0≦x≦1:

Cl may be at least partially substituted with fluorine (F). The fluorescent materials may each contain, as an activating agent, at least one of Sb and Mn.

From the above-mentioned fluorescent materials, the fluorescent materials to be used are appropriately selected. With respect to the longer-wavelength-fluorescent material, it is desirable to use, out of these fluorescent materials, a fluorescent material having a narrow half width.

The half width of any fluorescent material is decided mainly in accordance with the kinds of an activating agent therein. As a fluorescent material having a particularly narrow half width, use may be made of a fluorescent material containing, as a light emitting site (activating agent), at least one selected from the group including Eu, Mn, Tb, Sm, Dy and Pr.

With respect to the fluorescent material layer, the description has been made, giving, as an example, a laminated structure composed of first and second fluorescent material layers. However, the fluorescent material layer may have a structure wherein the first and second fluorescent materials are mixed with each other to be contained in a single fluorescent material layer.

While certain embodiments have been described, these embodiments have been presented by way of example only, and are not intended to limit the scope of the inventions. Indeed, the white light emitting device described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A white light emitting device, comprising:
a light emitting element having a peak wavelength in a wavelength range from 430 to 470 nm both inclusive,
a first fluorescent material formed over the light emitting element, and emitting light having a first peak wavelength of 530 to 580 nm both inclusive and having a first half width (FWHM), and
a second fluorescent material formed over the light emitting element, and emitting light having a second peak wavelength that is longer than the first peak wavelength and ranges from 570 to 620 nm both inclusive, and having a second half width (FWHM) that is 100 nm or less and is equal to or narrower than the first half width.

2. The device according to claim 1, wherein the first peak wavelength is 550 nm or less.

3. The device according to claim 1, wherein the second half width is 60 nm or less.

4. The device according to claim 1, wherein the difference between the first peak wavelength and the second peak wavelength is 40 nm or more.

5. The device according to claim 1, wherein the light emitting element is a blue LED.

6. A white light emitting device, comprising:
a substrate,
a light emitting element mounted on the substrate, and having a peak wavelength in a wavelength range from 430 to 470 nm both inclusive,
a first fluorescent material layer formed over the light emitting element, and comprising a first fluorescent material emitting light having a first peak wavelength of 530 to 580 nm both inclusive and having a first half width (FWHM), and
a second fluorescent material layer formed over the first fluorescent material layer, and comprising a second fluorescent material emitting light having a second peak wavelength that is longer than the first peak wavelength and ranges from 570 to 620 nm both inclusive, and having a second half width (FWHM) that is 100 nm or less and is equal to or narrower than the first half width.

7. The device according to claim 6, wherein the first peak wavelength is 550 nm or less.

8. The device according to claim 6, wherein the second half width is 60 nm or less.

9. The device according to claim 6, wherein the difference between the first peak wavelength and the second peak wavelength is 40 nm or more.

10. The device according to claim 6, wherein the light emitting element is a blue LED.

11. The device according to claim 6, wherein the light emitting element and the first fluorescent material layer have, therebetween, an element sealing transparent layer comprising a transparent resin.

12. The device according to claim 6, wherein a cross section of each of the first and second fluorescent material layers, perpendicular to the plane of the substrate has a semispherical outer circumferential shape.
